(19) United States
(12) Patent Application Publication
(10) Pub. No.: US 2025/0362671 A1
(43) Pub. Date: Nov. 27, 2025

(54) ROOT CAUSE ANALYSIS FOR ALARM EVENTS

(71) Applicant: Honeywell International Inc., Charlotte, NC (US)

(72) Inventors: Arnab Bhattacharjee, Bangalore (IN); Sourav Kayal, Bangalore (IN); Dipanjan Saha, Bangalore (IN); Nikhil Bansal, Bangalore (IN)

(21) Appl. No.: 18/669,568

(22) Filed: May 21, 2024

(51) Int. Cl. G05B 23/02

(52) U.S. Cl. CPC G05B 23/0275; G05B 23/0262

(57) ABSTRACT

Techniques for performing root cause analysis for alarm events are described. In operation, an indication for performing root cause analysis corresponding to an alarm event for a first asset within an industrial facility is received. A second asset related to the first asset within the industrial facility is then identified based on a hierarchical relationship amongst a plurality of assets within the industrial facility, where the hierarchical relationship is indicative of operational inter-dependability amongst the plurality of assets within the industrial facility, and the hierarchical relationship is stored in a first database instance. Thereafter, operating parameter characteristics of the first asset and the second asset are obtained, where the operating parameter characteristics correspond to the operating parameters of the first asset and the second asset, and the operating parameters characteristics are obtained from a plurality of second database instances communicatively coupled to the first database instance. The operating parameters characteristics of the first asset are then associated with operating parameter characteristics of the second asset to establish a causative correlation between the alarm event and the operation of the second asset. Thereafter, root cause analysis is performed using the associated operating parameter characteristics. Subsequently, operating parameters of at least one of the first asset and the second asset are modified for mitigating the alarm event.

### BACKGROUND

Industrial facilities include a plurality of assets for performing various operations, where each of the plurality of assets is configured to operate differently. For instance, when an industrial facility is a manufacturing unit for a product, the configuration of an asset from the plurality of assets may be decided based on characteristics and features of the product. Further, when the plurality of assets operates as per their configuration, various operating parameters of the assets are recorded and analyzed for monitoring operations of the assets.

### BRIEF DESCRIPTION OF DRAWINGS

FIG. 1 illustrates an environment for implementing an alarm event mitigation system, in accordance with an example of the present subject matter,

FIG. 2 illustrates the environment for implementing the alarm event mitigation system, in accordance with another example of the present subject matter,

FIG. 3 illustrates the environment for implementing the alarm event mitigation system, in accordance with yet another example of the present subject matter,

FIG. 4 illustrates a flow diagram for facilitating root cause analysis for alarm events associated with an asset within an industrial facility, in accordance with another example of the present subject matter,

FIG. 5 illustrates a schematic of the alarm event mitigation system, in accordance with an example of the present subject matter,

FIG. 6 illustrates the schematic of the alarm event mitigation system, in accordance with another example of the present subject matter,

FIG. 7 illustrates a method for facilitating root cause analysis for alarm events associated with the asset, in accordance with an example of the present subject matter,

FIG. 8 illustrates the method for facilitating root cause analysis for alarm events associated with the asset, in accordance with another example of the present subject matter,

FIG. 9 illustrates the method for facilitating root cause analysis for alarm events associated with the asset, in accordance with yet another example of the present subject matter,

FIG. 10 illustrates a method for ingesting operating parameter characteristics for a plurality of assets within the industrial facility in a plurality of database instances, in accordance with an example of the present subject matter,

FIG. 11 illustrates a non-transitory computer-readable medium for facilitating root cause analysis for alarm events associated with the asset, in accordance with another example of the present subject matter, and

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

Operations of an asset are monitored for detecting any deviations in operating parameters of the asset. Such monitoring can either be performed on a monitoring system that may either be present onsite, i.e., at the industrial facility, or at a remote location. In operation, the monitoring system records various operating parameters of the asset during operation of the asset. The monitoring system then compares the operating parameters against various thresholds. If any of the operating parameters is detected to be beyond a respective threshold, an alarm event is detected. In such a situation, the monitoring system notifies an operator of the asset to initiate a corrective action to mitigate the alarm event.

To optimize the detection and mitigation of the alarm events, known methods for mitigation of the alarm events involve utilization of autonomous systems for analyzing the recorded operating parameters and initiating corrective actions in situations of generation of alarm events.

Generally, different assets may be monitored by different autonomous systems within an industrial facility. For instance, for an asset such as a motor, a first autonomous system may monitor the speed and heat generated by the motor during the motor's operation. In such a situation, if an alarm event is generated upon detecting the speed of the motor to be below a threshold, the first autonomous system may initiate a corrective action by increasing the power being supplied to the motor to mitigate the alarm event, i.e., to increase the speed of the motor. However, increasing the power being supplied to the motor may also increase the amount of heat being generated during the motor's operation. When the amount of heat being generated breaches a threshold, another alarm event may be generated. In such a situation, the first autonomous system may then initiate another corrective action for reducing the amount of heat being generated during the motor's operation. Similarly, for another asset such as a boiler, a second autonomous system may be utilized to monitor the operating parameters of the boiler and take corrective actions in situations of generation of different alarm events.

As may be noted, known methods for detection and mitigation of the alarm events primarily rely upon monitoring and analysis of individual operating parameters of the asset so that, immediate corrective actions can be undertaken to resolve the generated alarm events and does not consider any link that may exist between the various operating parameters of the asset.

Further, there are instances where modifying the operating parameters of an asset may affect the operation of another asset. For instance, for an asset such as a conveyer belt, an alarm event may be generated upon detecting the speed of the conveyer belt to be below a threshold. The speed of the conveyer belt may have been reduced, for example, due to placement of a load heavier than a rated weight on the conveyer belt. In such a situation, an autonomous system monitoring the operation of the conveyer belt may initiate a corrective action by increasing the speed of a motor driving the conveyer belt. However, increasing the speed of the motor may also increase the temperature of the motor. When the temperature of the motor breaches a threshold, another alarm event may be generated. In such a situation, another autonomous system monitoring the operation of the motor may initiate another corrective action for reducing the temperature of the motor by decreasing the speed of the motor. In such a situation, a deadlock in operation of the conveyer belt and the motor may be created, which may require intervention from a human operator for resolution.

Thus, even in situations where the operation of different assets is interlinked, known methods for detection and mitigation of the alarm events primarily relies upon monitoring and analysis of individual operating parameters of the respective assets and do not consider any linkage between operating parameters and their changes, amongst different assets.

Accordingly, known methods are limited to performing instantaneous detection and mitigation of the alarm events. As a result, configuration of different assets within the industrial facility gradually shifts away from an optimized asset configuration upon detection of various alarm events, thereby adversely affecting various operations being performed within the industrial facility.

According to examples of the present subject matter, techniques for facilitating root cause analysis for alarm events associated with an asset are described.

In an example implementation, an indication for performing root cause analysis corresponding to an alarm event may be received, where the alarm event may be generated for a first asset within an industrial facility. In an example, the root cause analysis may be performed in response to a user input. In another example, the root cause analysis may be performed in response to detection of the alarm event.

Upon receiving the indication for performing the root cause analysis, a second asset related to the first asset within the industrial facility may be identified. The second asset may be identified based on a hierarchical relationship amongst a plurality of assets within the industrial facility, where the hierarchical relationship is indicative of operational inter-dependability amongst the plurality of assets within the industrial facility. In an example, the hierarchical relationship may be stored in a first database instance, where the first database instance may be a graph database instance.

Thereafter, operating parameter characteristics of the first asset and the second asset may be obtained. The operating parameter characteristics correspond to the operating parameters of the first asset and the second asset, where the operating parameters of the first asset and the second asset are indicative of operation of the first asset and the second asset. Further, the operating parameter characteristics are obtained from a plurality of second database instances communicatively coupled to the first database instance. In the example, the plurality of second database instances may include at least one of a versioned database and time series database instance.

The operating parameter characteristics of the first asset may then be associated with operating parameter characteristics of the second asset to establish a causative correlation between the alarm event and the operation of the second asset. The associated operating parameter characteristics may then be to perform root cause analysis, which may reveal the underlying issues that lead to the generation of the alarm event. Based on the root cause analysis, operating parameters of at least one of the first asset and the second asset may be modified for mitigating the alarm event.

By considering the interdependencies between different assets and their respective operating parameters, root cause analysis corresponding to different alarm events is performed that facilitates initiation of effective and sustainable corrective actions for such alarm events.

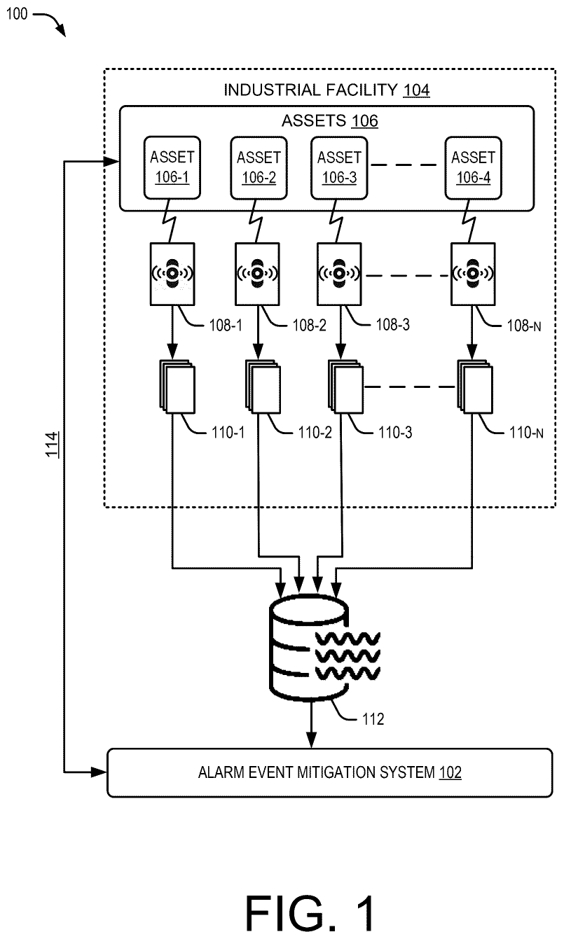

The above techniques are further described with reference to FIGS. 1 to 10. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates an environment 100 for implementing an alarm event mitigation system 102, in accordance with an example of the present subject matter. The environment 100 may include an industrial facility 104, where the industrial facility 104 may have a plurality of assets 106-1, 106-2, 106-3, . . . , 106-n. For the ease of reference, the plurality of assets 106-1, 106-2, 106-3, . . . , 106-n has been referred to as the assets 106, hereinafter.

In an example, the alarm event mitigation system 102 may be configured to monitor operations of the assets 106 for detecting occurrence of alarms events associated with an asset, such as a first asset 106-1, from the plurality of assets 106 and initiating corrective actions for mitigating the alarm events. It would be noted that an alarm event associated with the first asset 106-1 may be generated when it is detected that a deviation in an operating parameter of the first asset 106-1 is beyond a threshold.

Examples of the industrial facility 104 may include, but are not limited to, automobile assembly facilities, electronics manufacturing facilities, pharmaceutical production facilities, food processing plants, power plants, oil refineries, natural gas processing plants, steel mills, smelting plants, cement plants, water treatment facilities, wastewater treatment plants, warehouse and distribution centres, and port and shipping facilities. Further, examples of the assets 106 at the industrial facility 104 may vary based on a type of industrial facility 104. For instance, when the industrial facility 104 is an iron and steel factory, examples of the assets 106 may include, but are not limited to, hot coil conveyers, de-coiler machine, rotary kiln and cooler, continuous casting machine, cold box equipment, air purification vessel, roller table, ladle turret, and waste heat recovery boiler. Further, when the industrial facility 104 is a chemical factory, examples of the assets 106 may include, but are not limited to, heat exchangers, centrifugal machines, hot air generators, chemical reactor vessels, mixing tanks, and chemical storage tanks.

The environment 100 may include various sensors 108-1, 108-2, 108-3, . . . , 108-N mounted onto or communicatively coupled to the assets 106 for monitoring various operating parameters of the assets 106. A type of sensor mounted onto the assets 106, such as the first asset 106-1, may vary based on the parameter being monitored. For instance, in an example, when the industrial facility 104 is the iron and steel factory, the first asset 106-1 is a hot coil conveyer, and the parameter to be monitored is temperature of a part of the hot coil conveyer, a temperature sensor may be mounted onto the hot coil conveyer. In another example, when the industrial facility 104 is the chemical factory, the first asset 106-1 is a centrifugal machine, and the parameter to be monitored is rotational speed of the centrifugal machine, a rotational speed sensor may be mounted onto the centrifugal machine.

Further, the sensors 108-1, 108-2, 108-3, . . . , 108-N may be communicatively coupled to a data lake 112. In an example, the sensors 108-1, 108-2, 108-3, . . . , 108-N may monitor the operation of the assets 106 and generate sensor data 110-1, 110-2, 110-3, . . . , 110-N accordingly. The sensors 108-1, 108-2, 108-3, . . . , 108-N may then transmit the sensor data 110-1, 110-2, 110-3, . . . , 110-N to the data lake 112. The sensor data 110 may be stored in the data lake 112. In an example, the sensor data 110 may be stored in the data lake 112 in raw format. For ease of reference, the sensors 108-1, 108-2, 108-3, . . . , 108-N and the sensor data 110-1, 110-2, 110-3, . . . , 110-N are hereinafter referred to as sensors 108 and the sensor data 110, respectively.

In an example, the data lake 112 may further be coupled to the alarm event mitigation system 102. In the example, the alarm event mitigation system 102 may access the sensor data 110 from the data lake and transform the sensor data 110 to generate transformed sensor data. The data lake 112 may transform the sensor data 110 to ensure that the sensor data 110 conforms to a data format being utilized by alarm event mitigation system 102. The alarm event mitigation system 102 may transform the sensor data 110 using various known data transformation standards. Accordingly, the manner in which the sensor data 110 is transformed by the alarm event mitigation system 102 is not described for the sake of brevity.

In an example, the alarm event mitigation system 102 may further be controllably coupled to the assets 106. In the example, the alarm event mitigation system 102 may be controllably coupled to the assets 106 via a communication network 114. The communication network 114 can be a wireless or a wired network, or a combination thereof. Further, the communication network 114 can be a collection of individual networks, interconnected with each other and functioning as a single large network. Thus, when the alarm event is detected, the alarm event mitigation system 102 may initiate a corrective action for mitigating the alarm event. The alarm event mitigation system 102 may initiate the corrective action by modifying the operating parameters of the assets 106.

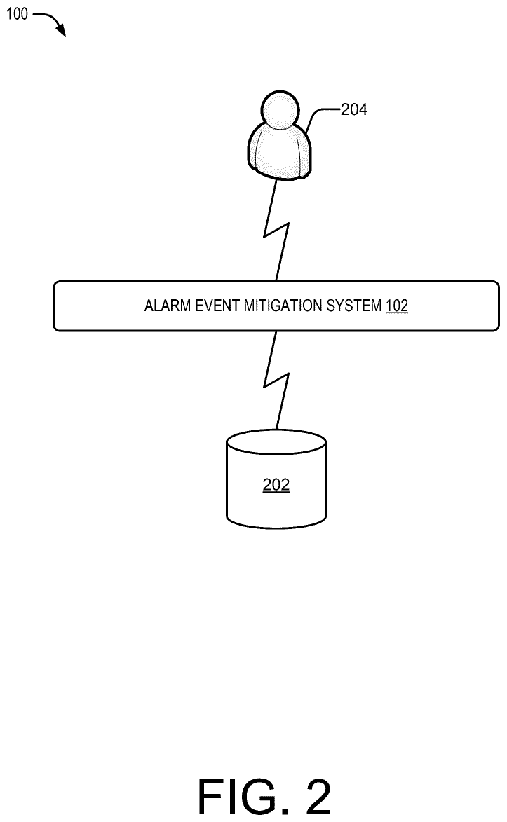

FIG. 2 illustrates the environment 100 for implementing the alarm event mitigation system 102, in accordance with another example of the present subject matter. As illustrated, the environment may include a first database instance 112 communicatively coupled to the alarm event mitigation system 102. In an example, the first database instance 112 may store a hierarchical relationship amongst the plurality of assets 106 within the industrial facility 104. The hierarchical relationship may be indicative of operational inter-dependability amongst the plurality of assets within the industrial facility. Further, the hierarchical relationship may be received from a user 204, such as an operator at the industrial facility responsible for monitoring the operation of the assets 106.

In addition to the first database instance 202, the environment 100 may also include a user interface or input mechanism, through which the user 204 may interact with the alarm event mitigation system 102. The user 204 may provide inputs, such as commands to initiate root cause analysis, or receive notifications and guidance on corrective actions to be taken in response to alarm events. The alarm event mitigation system 102, by leveraging the hierarchical relationship from the first database instance 202 and the user inputs from the user 204, is equipped to perform a comprehensive analysis of alarm events. This enables the system to not just react to immediate issues but also to understand and address underlying causes, thereby improving the overall reliability and efficiency of the industrial facility 104 operations.

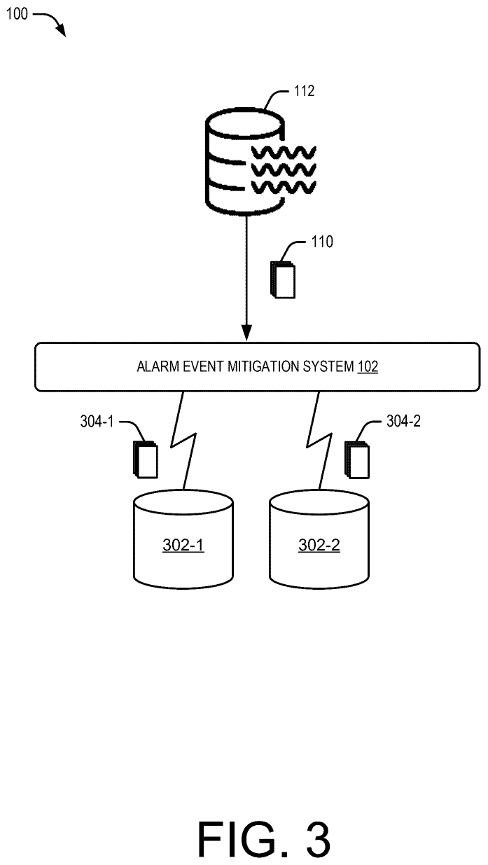

FIG. 3 illustrates the environment 100 for implementing the alarm event mitigation system 102, in accordance with yet another example of the present subject matter. As illustrated, the environment 100 may include a plurality of second database instances 302-1 and 302-2 communicatively coupled to the alarm event mitigation system 102. In an example, upon receiving the sensor data 110 from the data lake 112, the alarm event mitigation system 102 may transform the sensor data 110 to generate transformed sensor data 304-1 and 304-2. In the example, the transformation process may involve standardizing data formats, normalizing values, and other data processing steps to ensure compatibility with the alarm event mitigation system's analytical tools.

The alarm event mitigation system 102 may then transmit the transformed sensor data 304 to the plurality of second database instances 302-1 and 302-2. In an example, the alarm event mitigation system 102 may transmit the transformed sensor data 304 to the plurality of second database instances 302-1 and 302-2 based on a type of the transformed sensor data 304. For instance, the transformed sensor data 304 that varies frequently, such as transformed sensor data 304-1, may be transmitted to a timeseries database instance 302-1, which may be optimized for handling time-stamped data that changes over time. On the other hand, the transformed sensor data 304 that varies less frequently, such as the transformed sensor data 304-2, may be transmitted to a versioned database instance 302-2, which may be configured to maintain different versions of data records.

The transformed sensor data 304 may be indicative of operating parameters of the assets 106, where the operating parameters are indicative of the operation of the assets. Accordingly, the alarm event mitigation system 102 may monitor various operation parameters of the assets 106, through the received transformed sensor data 304. The alarm event mitigation system 102 may monitor the various operation parameters to detect occurrence of the alarm event associated with the assets 106 at the industrial facility 104.

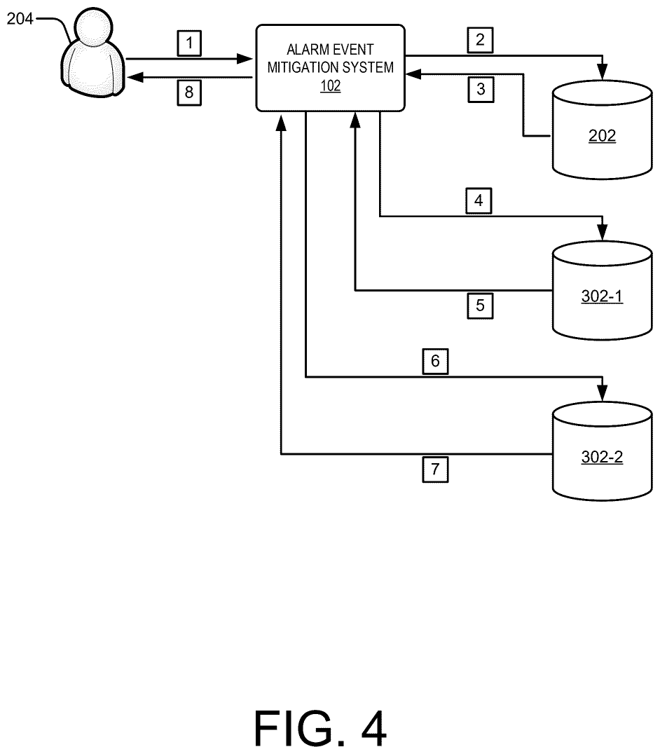

FIG. 4 illustrates a flow diagram for facilitating root cause analysis of alarm events for an asset, in accordance with an example of the present subject matter. The process begins at step 1, where the alarm event mitigation system 102 receives an indication for performing root cause analysis of an alarm event for the first asset 106-1 within the industrial facility. The indication may come from a user input or be automatically triggered by the detection of the alarm event. At steps 2 and 3, upon receiving the indication, the alarm event mitigation system 102 may access the first database instance 202 and retrieve a relationship lineage related to the first asset 106-1. The alarm event mitigation system may then utilize the relationship lineage to identify at least one asset from the plurality of assets 106 that may be functionally linked to the first asset 106-1. In an example, the at least one asset functionally linked to the first asset 106-1 may be a second asset 106-2.

At steps 4, 5, 6, and 7, the alarm event mitigation system 102 may obtain operating parameter characteristics of the first asset 106-1 and the second asset 106-2. The alarm event mitigation system 102 may obtain operating parameter characteristics of the first asset 106-1 and the second asset 106-2 from the plurality of second database instances 302-1 and 302-2. The operating parameter characteristics may correspond to the operating parameters of the first asset 106-1 and the second asset 106-2. Further, the operating parameters of the first asset and the second asset may be indicative of operation of the first asset and the second asset, respectively. The operating parameter characteristics may include historical alarm events, actions initiated in response to the alarm events, instantaneous parameter values of the operating parameters, or a combination thereof.

The alarm event mitigation system 102 may then associate the operating parameter characteristics of the second asset 106-2 with operating parameter characteristics of the first asset 106-1. In an example, the alarm event mitigation system 102 may associate the operating parameter characteristics of the first asset 106-1 with the operating parameter characteristics of the second asset 106-2 to establish a causative correlation between the alarm event and the operation of the second asset 106-2. Based on the association, the alarm event mitigation system 102 may perform the root cause analysis for the alarm event.

At step 8, the alarm event mitigation system 102 may transmit instructions to mitigate the alarm event to the operator 204. Alternatively, the alarm event mitigation system 102 may modify operating parameters of at least one of the first asset and the second asset for mitigating the alarm event.

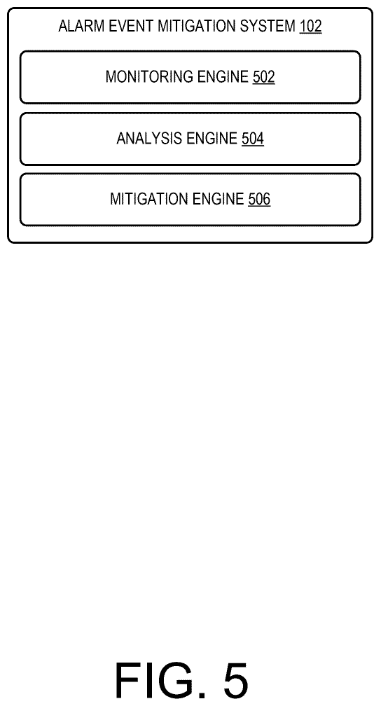

FIG. 5 illustrates a schematic of the alarm event mitigation system 102, in accordance with an example of the present subject matter.

In an example, the alarm event mitigation system 102 may include a monitoring engine 502 to monitor the first asset 106-1 for detecting the alarm event. The alarm event mitigation system 102 may further include an analysis engine 504 coupled to the monitoring engine 502. The analysis engine 504 may identify a second asset 106-2 operationally related to the first asset 106-1 within the industrial facility upon detection of the alarm event. The analysis engine 504 may identify the second asset 106-2 based on the hierarchical relationship amongst the assets 106 within the industrial facility. As already explained, the hierarchical relationship may be indicative of operational inter-dependability amongst the assets 106 within the industrial facility. Further, the hierarchical relationship may be stored in the first database instance 202.

The analysis engine 504 may then identify correlated operating parameters of the first asset 106-1 and the second asset 106-2 from the hierarchical relationship. As already explained, the operating parameters of the first asset and the second asset may be indicative of operation of the first asset 106-1 and the second asset 106-2. The analysis engine 504 may then obtain operating parameter characteristics of the first asset 106-1 and the second asset 106-2, where the operating parameter characteristics correspond to the correlated operating parameters. Further, the analysis engine 504 may obtain the operating parameter characteristics from a plurality of second database instances communicatively coupled to the first database instance.

The analysis engine 504 may then associate the operating parameter characteristics of the first asset with operating parameter characteristics of the second asset to establish a causative correlation between the alarm event and the operation of the second asset.

The alarm event mitigation system 102 may further include a mitigation engine 506 coupled to the analysis engine 504. In an example, the mitigation engine 506 may perform the root cause analysis for the alarm event using associated operating parameter characteristics of the first asset and the second asset. Subsequently, the mitigation engine 506 may initiate a corrective action for the alarm event by modifying operating parameters of at least one of the first asset and the second asset.

FIG. 5 illustrates a schematic of the alarm event mitigation system 102, in accordance with another example of the present subject matter. As already described, the alarm event mitigation system 102 may be configured to monitor operations of the assets 106 for detecting occurrence of alarms events associated with the plurality of assets 106 and initiating corrective actions for mitigating the alarm events.

In an example, the alarm event mitigation system 102 includes a processor 602 and a memory 604 coupled to the processor 602. The functions of the various elements shown in the FIGs., including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, conventional and/or custom, may also be included.

The memory 604 may include any computer-readable medium including, for example, volatile memory (e.g., RAM), and/or non-volatile memory (e.g., EPROM, flash memory, etc.).

The interface 606 may allow the connection or coupling of the alarm event mitigation system 102 with one or more other devices, through a wired (e.g., Local Area Network, i.e., LAN) connection or through a wireless connection (e.g., Bluetooth®, WiFi). The interface 606 may also enable intercommunication between different logical as well as hardware components of the alarm event mitigation system 102.

The alarm event mitigation system 102 may further include engine(s) 608, where the engine(s) 608 may include the monitoring engine 502, the analysis engine 504, the mitigation engine 506, and a data ingestion engine 610. In an example, the engine(s) 608 may be implemented as a combination of hardware and firmware or software. In examples described herein, such combinations of hardware and firmware may be implemented in several different ways. For example, the firmware for the engine may be processor executable instructions stored on a non-transitory machine-readable storage medium and the hardware for the engine may include a processing resource (for example, implemented as either a single processor or a combination of multiple processors), to execute such instructions.

In the present examples, the machine-readable storage medium may store instructions that, when executed by the processing resource, implement the functionalities of the engine. In such examples, the alarm event mitigation system 102 may include the machine-readable storage medium storing the instructions and the processing resource to execute the instructions. In other examples of the present subject matter, the machine-readable storage medium may be located at a different location but accessible to the alarm event mitigation system 102 and the processor 602.

The alarm event mitigation system 102 may further include data 612, that serves, amongst other things, as a repository for storing data that may be fetched, processed, received, or generated by the engine(s) 608. In an example, the data 612 may include the monitoring data 614, the analysis data 616, the mitigation data 618, the ingested data 620, and other data 622. In an example, the data 612 may be stored in the memory 604.

In operation, the monitoring engine 502 may receive an indication for performing root cause analysis corresponding to an alarm event for the first asset 106-1. The indication may be received in various ways. In an example, the indication may be a user input, such as an input from an operator of the first asset 106-1. In another example, the indication may be the alarm event.

Upon receiving the indication, the analysis engine 504 may identify a second asset 106-2 operationally related to the first asset 106-1. The second asset may be identified based on the hierarchical relationship amongst a plurality of assets within the industrial facility. In an example, the hierarchical relationship may be stored in the first database instance 112. In the example, the hierarchical relationship may be received from a user aware of the inter-dependability amongst the assets 106.

The analysis engine 504 may subsequently obtain operating parameter characteristics of the first asset and the second asset. Examples of the operating parameter characteristics include historical alarm events, actions initiated in response to the alarm events, instantaneous parameter values of the operating parameters, or a combination thereof. In an example, the analysis engine 504 may be obtained from a plurality of second database instances 302-1 and 302-2 communicatively coupled to the first database instance 112. The analysis engine 504 may then store the operating parameter characteristics of the first asset and the second asset in the analysis data 616.

In an example, the plurality of second database instances may be populated with the operating parameter characteristics of the assets during the operation of the industrial facility 104. In the example, the data ingestion engine 610 may receive the operating parameter characteristics of the assets 106 during the operation of the industrial facility 104. The data ingestion engine 610 may then transform operating parameter characteristics of the assets in accordance with a transformation standard. The data ingestion engine 610 may then store the transformed operating parameter characteristics to the plurality of second database instances in accordance with a type of the operating parameter characteristics. For instance, the data ingestion engine 610 may store operating parameter characteristics, such as alarm events generated upon detecting changes in the instantaneous parameter values of the operating parameters and corrective actions initiated in response to the alarm events, in the versioned database instance. On the other hand, the data ingestion engine 610 may store operating parameter characteristics, such as the instantaneous parameter values of the operating parameters, in the timeseries database instance.

Thereafter, the analysis engine 504 may associate the operating parameter characteristics of the first asset with operating parameter characteristics of the second asset to establish a causative correlation between the alarm event and the operation of the second asset. In an example, to associate the operating parameter characteristics of the first asset with the operating parameter characteristics of the second asset, the alarm event mitigation system 102 may initially identify at least one operating parameter of the first asset that corresponds to the alarm event. The alarm event mitigation system 102 may then identify the patterns and anomalies in operating parameter characteristics of the first asset and the second asset that coincide with the alarm event. The analysis engine 504 may then model the relationship between operating parameter deviation of the first asset and the operational state of the second asset. Subsequently, the analysis engine 504 may perform a sensitivity analysis to determine the impact of the operating parameters of the second asset on the operating parameter deviation of the first asset to identify the operating parameters of the second asset with the greatest influence on the parameter deviation.

The alarm event mitigation system 102 may then perform the root cause analysis using the associated operating parameter characteristics which may reveal the underlying issues that lead to the generation of the alarm event. The alarm event mitigation system 102 may accordingly modify operating parameters of at least one of the first asset and the second asset for mitigating the alarm event.

In an illustrative example, the industrial facility 104 may be a chemical processing plant and the first asset may be a reactor vessel. In operation, the monitoring engine 502 may continuously monitor the reactor vessel to detect an alarm event indicative of temperature deviation beyond a threshold. When the alarm event is detected, the monitoring engine 502 may identify a second asset directly linked to the temperature regulation of the reactor vessel, such as a heat exchanger. In an example, the monitoring engine 502 may identify the second asset based on the hierarchical relationship between the plurality of assets within the chemical processing plant, where the hierarchical relationship is stored in a graph database instance.

The analysis engine 504 may then obtain operating parameter characteristics related to the operating parameters, such as temperature readings, flow rates, and pressure levels, for the reactor vessel and the heat exchanger. The analysis engine 504 may obtain the operating parameter characteristics from the versioned database instance and the time series database instance.

The analysis engine 504 may then associate the operating parameter characteristics of the reactor vessel and the heat exchanger to establish a causative correlation between the temperature deviation in the reactor vessel the operational state of the heat exchanger. In an example, to associate the operating parameter characteristics of the reactor vessel and the heat exchanger, the analysis engine 504 may preprocess the operating parameter characteristics to normalize the temperature readings, flow rates, and pressure levels for both the reactor vessel and the heat exchanger to a common scale. The analysis engine 504 may then execute a multivariate statistical analysis to identify patterns and anomalies in the operating parameter characteristics of the first asset and the second asset that coincide with the temperature deviation alarm condition. The analysis engine 504 may then utilize a causation inference engine that employs Bayesian networks to probabilistically model the relationship between the reactor vessel's temperature deviation and the heat exchanger's operational state. The analysis engine 504 may then perform a sensitivity analysis to determine the impact of the heat exchanger's operating parameters on the reactor vessel's temperature to identify the parameters with the greatest influence on the temperature deviation.

The mitigation engine 506 may then perform the root cause analysis of the temperature deviation based on the established causative correlation between the temperature deviation in the reactor vessel and the operational state of the heat exchanger. The mitigation engine 506 may subsequently modify operating parameters of at least one of the reactor vessel and the heat exchanger for mitigating the alarm event.

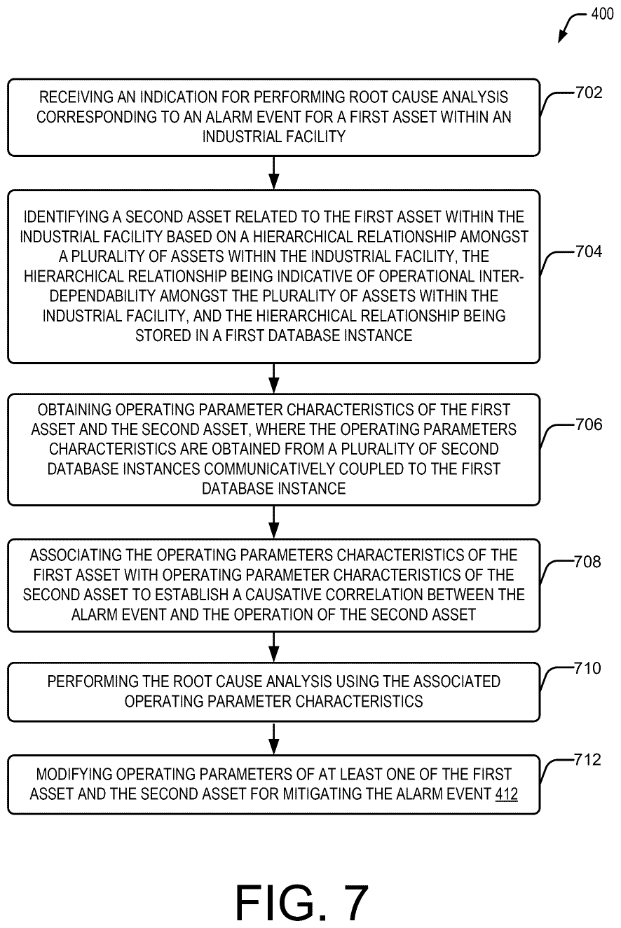

FIGS. 7, 8, and 9 illustrate methods 700, 800, and 900 for performing root cause analysis of an alarm event, in accordance with examples of the present subject matter. The order in which the methods are described is not intended to be construed as a limitation, and any number of the described method blocks may be combined in any order to implement the methods, or an alternative method. Further, the methods 700, 800, and 900 may be implemented by processing resource or computing device(s) through any suitable hardware, non-transitory machine-readable instructions, or combination thereof.

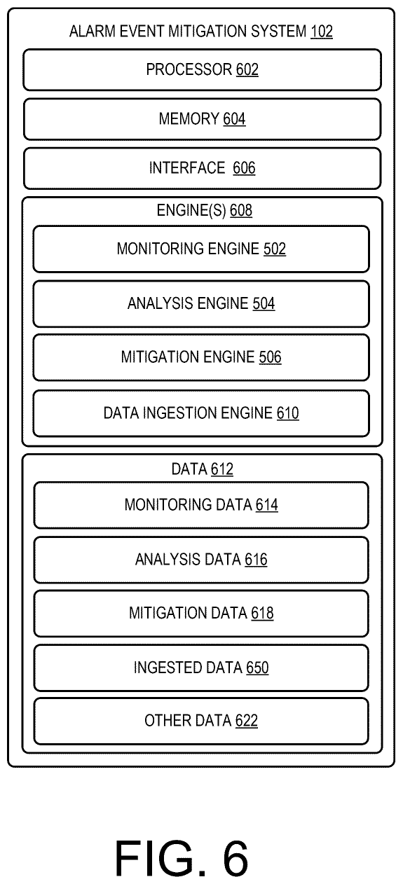

It may also be understood that methods 700, 800, and 900 may be performed by programmed computing devices, such as the alarm event mitigation system 102, as depicted in FIG. 6. Furthermore, the methods 700, 800, and 900 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 700, 800, and 900 are described below with reference to the alarm event mitigation system 102, as described above; other suitable systems for the execution of these methods may also be utilized. Additionally, implementation of the method is not limited to such examples.

In FIG. 7, at block 702, an indication for performing root cause analysis corresponding to an alarm event for a first asset within an industrial facility may be received. In an example, the indication for performing root cause analysis may be a user input from an operator of the first asset. In another example, the indication for performing root cause analysis may be detection of the alarm event. The indication for performing the root cause analysis may be received by the monitoring engine 502.

At block 704, a second asset related to the first asset within the industrial facility may be identified. The second asset may be identified based on a hierarchical relationship amongst a plurality of assets within the industrial facility, where the hierarchical relationship may be indicative of operational inter-dependability amongst the plurality of assets within the industrial facility. The hierarchical relationship may be stored in a first database instance, where the first database instance may be a graph database instance. Further, the hierarchical relationship may be received from a user. In an example, the second asset may be identified by the analysis engine 504.

At block 706, operating parameter characteristics of the first asset and the second asset may be obtained. The operating parameter characteristics may correspond to the operating parameters of the first asset and the second asset. Further, the operating parameters of the first asset and the second asset may be indicative of operation of the first asset and the second asset. The operating parameter characteristics may be obtained from a plurality of second database instances communicatively coupled to the first database instance, where plurality of second database instances include at least one of a versioned database instance and time series database instance. In an example, the operating parameter characteristics may be obtained by the analysis engine 504.

At block 708, the operating parameter characteristics of the first asset may be associated with operating parameter characteristics of the second asset to establish a causative correlation between the alarm event and the operation of the second asset. In an example, the operating parameter characteristics of the first asset may be associated with operating parameter characteristics of the second asset by the analysis engine 504.

At block 710, the root cause analysis may be performed using the associated operating parameter characteristics. In an example, the root cause analysis may be performed by the mitigation engine 506.

At block 712, operating parameters of at least one of the first asset and the second asset may be modified for mitigating the alarm event. In an example, the operating parameters of at least one of the first asset and the second asset may be modified by the mitigation engine 506.

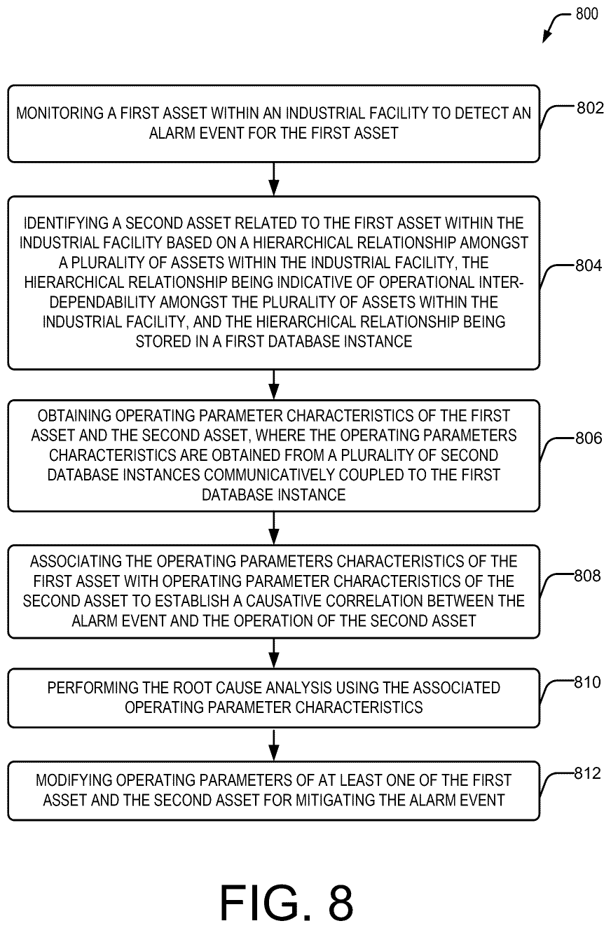

In FIG. 8, at block 802, a first asset within an industrial facility may be monitored to detect an alarm event. In an example, the first asset may be monitored by the monitoring engine 502.

At block 804, a second asset related to the first asset within the industrial facility may be identified. The second asset may be identified based on the hierarchical relationship amongst a plurality of assets within the industrial facility. The hierarchical relationship may be stored in a first database instance, where the first database instance may be a graph database instance. Further, the hierarchical relationship may be received from a user. In an example, the second asset may be identified by the analysis engine 504.

At block 806, operating parameter characteristics of the first asset and the second asset may be obtained. The operating parameter characteristics may correspond to the operating parameters of the first asset and the second asset. Further, the operating parameters of the first asset and the second asset may be indicative of operation of the first asset and the second asset. The operating parameter characteristics may be obtained from a plurality of second database instances communicatively coupled to the first database instance, where plurality of second database instances include at least one of a versioned database instance and time series database instance. In an example, the operating parameter characteristics may be obtained by the analysis engine 504.

At block 808, the operating parameter characteristics of the first asset may be associated with operating parameter characteristics of the second asset to establish a causative correlation between the alarm event and the operation of the second asset. In an example, the operating parameter characteristics of the first asset may be associated with operating parameter characteristics of the second asset by the analysis engine 504.

At block 810, the root cause analysis may be performed using the associated operating parameter characteristics. In an example, the root cause analysis may be performed by the mitigation engine 506.

At block 812, operating parameters of at least one of the first asset and the second asset may be modified for mitigating the alarm event. In an example, the operating parameters of at least one of the first asset and the second asset may be modified by the mitigation engine 506.

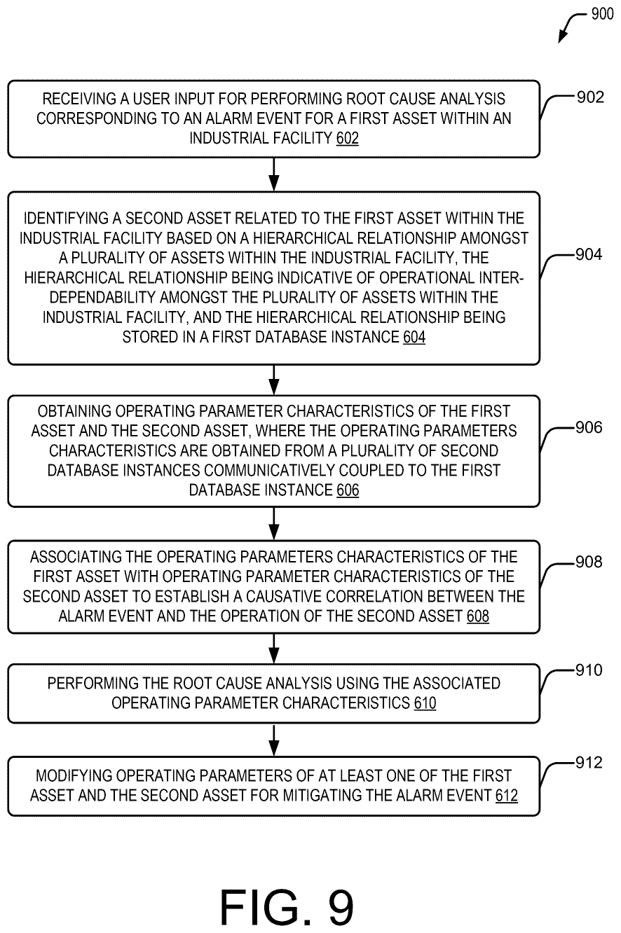

In FIG. 9, at block 902, a user input for performing root cause analysis corresponding to an alarm event for a first asset within an industrial facility may be received. In an example, the user input may be provided by an operator of the first asset, where the operator may be responsible for monitoring the operations of the first asset. In the example, the user input may be received by the monitoring engine 502.

At block 904, a second asset related to the first asset within the industrial facility may be identified. The second asset may be identified based on the hierarchical relationship amongst a plurality of assets within the industrial facility. The hierarchical relationship may be stored in a first database instance, where the first database instance may be a graph database instance. Further, the hierarchical relationship may be received from a user. In an example, the second asset may be identified by the analysis engine 504.

At block 906, operating parameter characteristics of the first asset and the second asset may be obtained. The operating parameter characteristics may correspond to the operating parameters of the first asset and the second asset. Further, the operating parameters of the first asset and the second asset may be indicative of operation of the first asset and the second asset. The operating parameter characteristics may be obtained from a plurality of second database instances communicatively coupled to the first database instance, where plurality of second database instances include at least one of a versioned database instance and time series database instance. In an example, the operating parameter characteristics may be obtained by the analysis engine 504.

At block 908, the operating parameter characteristics of the first asset may be associated with operating parameter characteristics of the second asset to establish a causative correlation between the alarm event and the operation of the second asset. In an example, the operating parameter characteristics of the first asset may be associated with operating parameter characteristics of the second asset by the analysis engine 504.

At block 910, the root cause analysis may be performed using the associated operating parameter characteristics. In an example, the root cause analysis may be performed by the mitigation engine 506.

At block 912, operating parameters of at least one of the first asset and the second asset may be modified for mitigating the alarm event. In an example, the operating parameters of at least one of the first asset and the second asset may be modified by the mitigation engine 506.

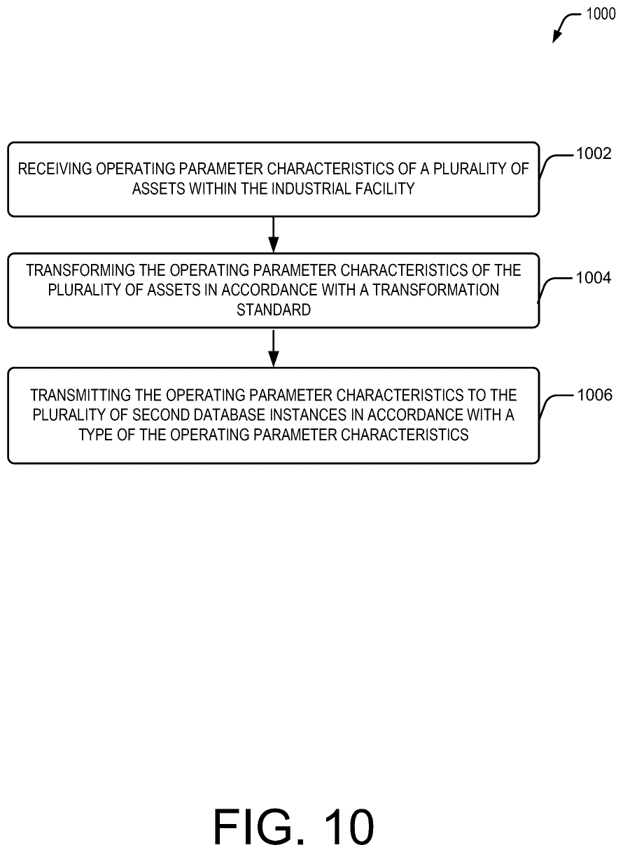

FIG. 10 illustrates a method 1000 for ingesting the operating parameter characteristics in the plurality of second database instances, in accordance with examples of the present subject matter. The order in which the methods are described is not intended to be construed as a limitation, and any number of the described method blocks may be combined in any order to implement the methods, or an alternative method. Further, the method 1000 may be implemented by processing resource or computing device(s) through any suitable hardware, non-transitory machine-readable instructions, or combination thereof.

It may also be understood that method 1000 may be performed by programmed computing devices, such as the alarm event mitigation system 102, as depicted in FIG. 6. Furthermore, the method 1000 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 1000 is described below with reference to the alarm event mitigation system 102, as described above; other suitable systems for the execution of these methods may also be utilized. Additionally, implementation of the method is not limited to such examples.

At block 1002, operating parameter characteristics of a plurality of assets within the industrial facility may be received. The operating parameter characteristics may include at least historical alarm events, actions initiated in response to the alarm events, and the instantaneous parameter values of the operating parameters. In an example, the operating parameter characteristics of the plurality of assets may be received by the data ingestion engine 610.

At block 1004, the operating parameter characteristics of the plurality of assets may be transformed to in accordance with a transformation standard. it would be noted that the operating parameter characteristics may be transformed to ensure that the operating parameter characteristics conforms to a format that is suitable for analysis by the alarm event mitigation system 102. In an example, the operating parameter characteristics of the plurality of assets may be transformed by the data ingestion engine 610.

At block 1006, the operating parameter characteristics may be transmitted to the plurality of second database instances in accordance with a type of the operating parameter characteristics. For instance, the operating parameter characteristics, such as alarm events generated upon detecting changes in the instantaneous parameter values of the operating parameters and corrective actions initiated in response to the alarm events, may be transmitted to the versioned database instance. On the other hand, the operating parameter characteristics, such as the instantaneous parameter values of the operating parameters, may be transmitted to the time series database instance. In an example, the operating parameter characteristics may be transmitted to the plurality of second database instances by the data ingestion engine 610.

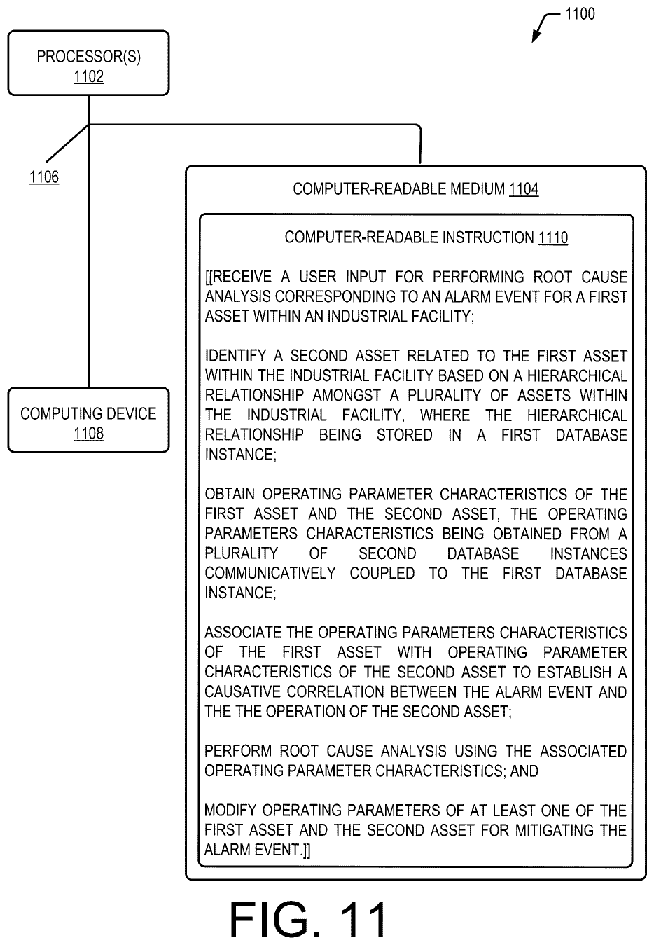

FIG. 11 illustrates a non-transitory computer-readable medium for performing root cause analysis for alarm events associated with an asset within an industrial facility, in accordance with an example of the present subject matter.

In an example, the computing environment 1100 includes processor 1102 communicatively coupled to a non-transitory computer readable medium 1104 through communication link 1106. In an example implementation, the computing environment 1100 may be for example, the alarm event mitigation system 102. In an example, the processor 1102 may have one or more processing resources for fetching and executing computer-readable instructions from the non-transitory computer readable medium 1104. The processor 1102 and the non-transitory computer readable medium 1104 may be implemented, for example, in the alarm event mitigation system 102.

The non-transitory computer readable medium 1104 may be, for example, an internal memory device or an external memory. In an example implementation, the communication link 1106 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 1104 includes a set of computer readable instructions 1110 which may be accessed by the processor 1102 through the communication link 1106 and subsequently executed for performing root cause analysis for the alarm events. The processor(s) 1102 and the non-transitory computer readable medium 1104 may also be communicatively coupled to a computing device 1108 over the network.

Referring to FIG. 11, in an example, the non-transitory computer readable medium 1104 includes computer readable instructions 1110 that cause the processor 1102 to receive a user input for performing root cause analysis corresponding to an alarm event for a first asset within an industrial facility. The instructions 1110 may then cause the processor 1102 to identify a second asset related to the first asset within the industrial facility. In an example, the second asset may be identified based on a hierarchical relationship amongst a plurality of assets within the industrial facility, where the hierarchical relationship is indicative of operational inter-dependability amongst the plurality of assets within the industrial facility. In the example, the hierarchical relationship may be stored in a first database instance, where the first database instance may be a graph database instance. Further, the hierarchical relationship may be received from a user.

The instructions 1110 may further cause the processor 1102 to obtain operating parameter characteristics of the first asset and the second asset. The operating parameter characteristics may correspond to the operating parameters of the first asset and the second asset. Further, the operating parameters of the first asset and the second asset may be indicative of operation of the first asset and the second asset. The operating parameter characteristics may include historical alarm events, actions initiated in response to the alarm events, instantaneous parameter values of the operational parameters, or a combination thereof.

The operating parameters characteristics may be obtained from a plurality of second database instances communicatively coupled to the first database instance. In an example, the plurality of second database instances may include at least one of a versioned database and time series database instance.

The instructions 1110 may then cause the processor 1102 to associate the operating parameters characteristics of the first asset with operating parameter characteristics of the second asset to establish a causative correlation between the alarm event and the operation of the second asset. In an example, to associate the operating parameter characteristics of the first asset with the operating parameter characteristics of the second asset, the instructions 1110 may then cause the processor 1102 to identify at least one operating parameter of the first asset that corresponds to the alarm event. The instructions 1110 may then cause the processor 1102 to identify the patterns and anomalies in operating parameter characteristics of the first asset and the second asset that coincide with the alarm event. Thereafter, the instructions 1110 may then cause the processor 1102 to model the relationship between operating parameter deviation of the first asset and the operational state of the second asset. Subsequently, the instructions 1110 may then cause the processor 1102 to perform a sensitivity analysis to determine the impact of the operating parameters of the second asset on the operating parameter deviation of the first asset to identify the operating parameters of the second asset with the greatest influence on the parameter deviation.

The instructions 1110 may then cause the processor 1102 to perform root cause analysis using the associated operating parameter characteristics. The instructions may further cause the processor 1102 to modify operating parameters of at least one of the first asset and the second asset for mitigating the alarm event.

In an example, the instructions 1110 may further cause the processor 1102 to populate the plurality of second database instances with the operating parameter characteristics of the assets during the operation of the industrial facility 104. In the example, the instructions 1110 may cause the processor 1102 to receive the operating parameter characteristics of the assets 106 during the operation of the industrial facility 104. The instructions 1110 may cause the processor 1102 to transform operating parameter characteristics of the assets in accordance with a transformation standard. The instructions 1110 may then cause the processor 1102 to store the transformed operating parameter characteristics to the plurality of second database instances in accordance with a type of the operating parameter characteristics. For instance, the instructions 1110 may cause the processor 1102 to store the operating parameter characteristics, such as alarm events generated upon detecting changes in the instantaneous parameter values of the operating parameters and corrective actions initiated in response to the alarm events, in the versioned database instance. On the other hand, the instructions 1110 may cause the processor 1102 to store the operating parameter characteristics, such as the instantaneous parameter values of the operating parameters, in the timeseries database instance.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method comprising:
receiving an indication for performing root cause analysis corresponding to an alarm event for a first asset within an industrial facility;
identifying a second asset related to the first asset within the industrial facility based on a hierarchical relationship amongst a plurality of assets within the industrial facility, the hierarchical relationship being indicative of operational inter-dependability amongst the plurality of assets within the industrial facility, and the hierarchical relationship being stored in a first database instance;
obtaining operating parameter characteristics of the first asset and the second asset, the operating parameter characteristics being corresponding to the operating parameters of the first asset and the second asset, the operating parameters of the first asset and the second asset being indicative of operation of the first asset and the second asset, and the operating parameters characteristics being obtained from a plurality of second database instances communicatively coupled to the first database instance;
associating the operating parameters characteristics of the first asset with operating parameter characteristics of the second asset to establish a causative correlation between the alarm event and the operation of the second asset;
performing the root cause analysis using the associated operating parameter characteristics; and
modifying operating parameters of at least one of the first asset and the second asset for mitigating the alarm event.

2. The method of claim 1, wherein the first database instance comprises a graph database instance, the plurality of second database instances comprises at least one of a versioned database instance and time series database instance.

3. The method of claim 1, wherein the operating parameter characteristics comprises historical alarm events, actions initiated in response to the alarm events, and the instantaneous parameter values of the operational parameters.

4. The method of claim 1, wherein the indication for performing root cause analysis is a user input.

5. The method of claim 1, wherein the indication for performing root cause analysis is the alarm event for the first asset.

6. The method of claim 1, wherein the hierarchical relationship is received from a user.

7. The method of claim 2, further comprising:
receiving operating parameter characteristics of a plurality of assets within the industrial facility, the plurality of assets comprising the first asset and the second asset;
transforming the operating parameter characteristics of the plurality of assets in accordance with a transformation standard; and
transmitting the operating parameter characteristics to the plurality of second database instances in accordance with a type of the operating parameter characteristics.

8. The method of claim 7, wherein transferring the operating parameter characteristics comprises:
transmitting historical alarm events and actions initiated in response to the alarm events to the versioned database instance; and
transmitting the instantaneous parameter values of the operational parameters to the time series database instance.

9. An alarm event mitigation system comprising:
a monitoring engine to monitor a first asset within an industrial facility to detect an alarm event for the first asset;
an analysis engine coupled to the monitoring engine to:
identify a second asset operationally related to the first asset within the industrial facility upon detection of the alarm event, the second asset being identified based on a hierarchical relationship amongst a plurality of assets within the industrial facility, the hierarchical relationship being indicative of operational inter-dependability amongst the plurality of assets within the industrial facility, and the hierarchical relationship being stored in a first database instance;
obtain operating parameter characteristics of the first asset and the second asset, the operating parameter characteristics being corresponding to the operating parameters of the first asset and the second asset, the operating parameters of the first asset and the second asset being indicative of operation of the first asset and the second asset, and the operating parameter characteristics being obtained from a plurality of second database instances communicatively coupled to the first database instance; and
associate the operating parameters characteristics of the first asset with operating parameter characteristics of the second asset to establish a causative correlation between the alarm event and the operation of the second asset; and
an alarm mitigation engine coupled to the analysis engine to:
perform root cause analysis for the alarm event using the associated operating parameter characteristics; and
initiate a corrective action for the alarm event by modifying operating parameters of at least one of the first asset and the second asset.

10. The alarm event mitigation system of claim 9, wherein the first database instance comprises a graph database instance and the plurality of second database instances comprises at least one of a versioned database and time series database instance.

11. The alarm event mitigation system of claim 9, wherein the operating parameter characteristics comprises historical alarm events, actions initiated in response to the alarm events, and the instantaneous parameter values of the operational parameters.

12. The alarm event mitigation system of claim 9, wherein the analysis engine is to receive the hierarchical relationship from a user.

13. The alarm event mitigation system of claim 10, further comprising a data ingestion engine to:
receive operating parameter characteristics of a plurality of assets within the industrial facility, the plurality of assets comprising the first asset and the second asset;
transform the operating parameter characteristics of the plurality of assets in accordance with a transformation standard; and
transmit the operating parameter characteristics to the plurality of second database instances in accordance with a type of the operating parameter characteristics.

14. The alarm event mitigation system of claim 13, wherein to transfer the operating parameter characteristics, the data ingestion engine is to:
transmit historical alarm events and actions initiated in response to the alarm events to the versioned database; and
transmit the instantaneous parameter values of the operational parameters to the time series database.

15. A non-transitory computer readable medium comprising computer-readable instructions that when executed cause a processing resource of a computing device to:
receive a user input for performing root cause analysis corresponding to an alarm event for a first asset within an industrial facility;
identify a second asset related to the first asset within the industrial facility based on a hierarchical relationship amongst a plurality of assets within the industrial facility, the hierarchical relationship being indicative of operational inter-dependability amongst the plurality of assets within the industrial facility, and the hierarchical relationship being stored in a first database instance;
obtain operating parameter characteristics of the first asset and the second asset, the operating parameter characteristics being corresponding to the operating parameters of the first asset and the second asset, the operating parameters of the first asset and the second asset being indicative of operation of the first asset and the second asset, and the operating parameters characteristics being obtained from a plurality of second database instances communicatively coupled to the first database instance;
associate the operating parameters characteristics of the first asset with operating parameter characteristics of the second asset to establish a causative correlation between the alarm event and the operation of the second asset;
perform root cause analysis using the associated operating parameter characteristics; and
modify operating parameters of at least one of the first asset and the second asset for mitigating the alarm event.

16. The non-transitory computer readable medium of claim 15, wherein the first database instance comprises a graph database instance, the plurality of second database instances comprises at least one of a versioned database and time series database instance.

17. The non-transitory computer readable medium of claim 15, wherein the operating parameter characteristics comprises historical alarm events, actions initiated in response to the alarm events, and instantaneous parameter values of the operational parameters.

18. The non-transitory computer readable medium of claim 15, wherein the analysis engine is to receive the hierarchical relationship from a user.

19. The non-transitory computer readable medium of claim 16, further comprising the instructions to:
receive operating parameter characteristics of a plurality of assets within the industrial facility, the plurality of assets comprising the first asset and the second asset;
transform the operating parameter characteristics of the plurality of assets in accordance with a transformation standard; and
transfer the operating parameter characteristics to the plurality of second database instances in accordance with a type of the operating parameter characteristics.

20. The non-transitory computer readable medium of claim 19, further comprising the instructions to:
transmit historical alarm events and actions initiated in response to the alarm events to the versioned database; and
transmit the instantaneous parameter values of the operational parameters to the time series database.
